(19) United States
(12) Patent Application Publication
(10) Pub. No.: US 2014/0239869 A1
(43) Pub. Date: Aug. 28, 2014

(54) Electrical System

(71) Applicant: Bayerische Motoren Werke Aktiengesellschaft, Muenchen (DE)

(72) Inventors: Matthias GORKA, Muenchen (DE); Dominik HECKER, Muenchen (DE)

(73) Assignee: Bayerische Motoren Werke Aktiengesellschaft, Muenchen (DE)

(21) Appl. No.: 14/268,716

(22) Filed: May 2, 2014

Related U.S. Application Data
(63) Continuation of application No. PCT/EP2012/071458, filed on Oct. 30, 2012.

(30) Foreign Application Priority Data
Nov. 3, 2011 (DE) 102011085731.1

(51) Int. Cl. H02P 25/22

(52) U.S. Cl. CPC H02P 25/22
USPC 318/496

(57) ABSTRACT

An electrical system is provided. The electrical system includes a first 2-pole direct current source and/or sink, a second 2-pole direct current source and/or sink, a first 3-phase direct current/alternating current converter, a second 3-phase direct current/alternating current converter, and an electrical machine. The electrical machine is designed with 6 phases, and has a first 3-phase stator system and a second 3-phase stator system that are electrically isolated from each another.

### CROSS REFERENCE TO RELATED APPLICATIONS

This application is a continuation of PCT International Application No. PCT/EP2012/071458, filed Oct. 30, 2012, which claims priority under 35 U.S.C. §119 from German Patent Application No. 10 2011 085 731.1, filed Nov. 3, 2011, the entire disclosures of which are herein expressly incorporated by reference.

### BACKGROUND AND SUMMARY OF THE INVENTION

The invention relates to an electrical system which includes a first 2-pole direct current source and/or sink, a second 2-pole direct current source and/or sink, and an electrical machine.

Complex electrical systems frequently have a plurality of sub-systems which, depending on the situation, undertake a function as electrical power source or as electrical power sink in the overall system.

By way of example, the on-board power supply of a hybrid vehicle, such as can be seen in FIG. 1 of the publication US 2008/0011528 A1, can be cited as an electrical system of this kind. This electrical system has two electrical energy storage devices and a 3-phase electrical drive machine which can be operated in a motoring mode or a generating mode. One of the electrical energy storage devices is connected to the electrical machine by a direct current/alternating current converter and to the further energy storage device by a direct current controller in parallel with this converter.

When the direct current controller is designed to be bidirectional, both energy storage devices can drive the electrical machine in the motoring mode. The storage devices are then discharged. In the generating mode, both energy storage devices can be charged by the electrical machine. This usually takes place by recuperation.

An object of the invention is to specify an improved electrical system which includes a first 2-pole direct current source and/or sink, a second 2-pole direct current source and/or sink and an electrical machine.

According to exemplary embodiments of the invention, the electrical machine is designed with 6 phases and includes a first 3-phase stator system and a second 3-phase stator system which are electrically isolated from one another. According to exemplary embodiments of the invention, the electrical system further includes a first 3-phase direct current/alternating current converter and a second 3-phase direct current/alternating current converter.

This means that the electrical system in the form of the electrical machine has two stator systems and a rotor. As well as the stator systems, two direct current/alternating current converters are also part of the electrical system.

In addition, the first stator system is connected to the first direct current/alternating current converter on the alternating current side, and the second stator system is connected to the second direct current/alternating current converter on the alternating current side.

Accordingly, the three phases of the first stator system are electrically connected to the alternating current side of the first direct current/alternating current converter, and the three phases of the second stator system are electrically connected to the alternating current side of the second direct current/alternating current converter. This has the advantage that the two stator systems have an independent electrical connection in the electrical system.

According to a further embodiment of the invention, the first direct current source and/or sink is connected to the first direct current/alternating current converter on the direct current side, and the second direct current source and/or sink to the second direct current/alternating current converter on the direct current side.

The first direct current source and/or sink is therefore electrically connected to the direct current input of the first direct current/alternating current converter, and the second direct current source and/or sink to the direct current input of the second direct current/alternating current converter. Each of the two direct current sources and/or sinks is therefore electrically connected to one of the two stator systems of the electrical machine via a separate direct current/alternating current converter.

Furthermore, it can be expedient when the first direct current source and/or sink has a first nominal voltage level and the second direct current source and/or sink has a second nominal voltage level, wherein the first nominal voltage level is greater than the second nominal voltage level in the direction of higher homopolar voltage.

Electrical energy storage devices with different nominal voltage levels, for example, can therefore be included in the electrical system.

In addition, it is advantageous when the electrical system includes a first switch and a second switch, and the pole with the higher potential of the two poles of the first 2-pole direct current source and/or sink is connected to the pole with higher potential of the two poles of the second 2-pole direct current source and/or sink via a series circuit of the first switch and the second switch, and the pole with the higher potential of the two poles of the second 2-pole direct current source and/or sink is connected to the second direct current/alternating current converter via the second switch.

This means that both direct current sources and/or sinks each have a pole with higher electrical potential and a pole with lower electrical potential, e.g. connected to ground. The two poles of the two direct current sources and/or sinks which are at higher potential than the respective other pole of the direct current source and/or sink are connected in series with one another via the two switches.

Advantageously, the second switch is open when the first switch is closed, and the second switch is closed when the first switch is open.

This means that, preferably, both switches are never closed at the same time.

According to a further embodiment of the invention, when the first switch is closed and the second switch is open, it is advantageous when the first 2-pole direct current source and/or sink drives the electrical machine in motoring or generating mode via the first direct current/alternating current converter and the second direct current/alternating current converter.

In this configuration, the rotor of the electrical machine is driven by both stator systems. All 6 phases of the stator systems are operated in motoring machine mode by the two direct current/alternating current converters. The two converters are supplied with electrical energy from the first direct current source and/or sink.

In addition, when the first switch is open and the second switch is closed, it is advantageous when the first 2-pole direct current source and/or sink drives the electrical machine in motoring mode via the first direct current/alternating current converter and, when the first switch is open and the second switch is closed, the second 2-pole direct current source and/or sink charges the electrical machine in generating mode via the second direct current/alternating current converter.

In this configuration, the two stator systems are operated independently of one another in such a way that the first stator system operates the rotor in motoring mode and the second stator system operates the rotor in generating mode. A torque which drives the rotor is impressed on the first stator system by the first direct current/alternating current converter, and a braking torque in the form of induction voltage is impressed on the second stator system by the second direct current/alternating current converter. The induction voltage serves to charge the second direct current source/sink via the second direct current/alternating current converter.

Preferably, a vehicle includes the electrical system. This has the advantage that, when there are two sub-on-board power supplies in the vehicle, electrical power from both on-board power supplies can be converted into drive power for the vehicle by the two stator systems of the electrical machine. Further, both sub-on-board power supplies can be provided with electrical energy, for example in the form of recuperation. Alternatively, electrical power or energy can be transferred from one sub-on-board power supply into the other sub-on-board power supply by operating one stator system in motoring mode and the other stator system in generating mode.

The invention is based on the following considerations. Related art hybrid and electric vehicles have a high-voltage battery (approx. 300-400 volts) and a low-voltage battery. The high-voltage battery is connected to the electric motor via an inverter (rectifier/inverter). The low-voltage battery supplies the 12 volt on-board power supply and therefore powers consumers such as a radio, light, etc.

The low-voltage battery is charged from the high-voltage battery by a DC/DC converter. Related art hybrid vehicles therefore always have a rectifier/inverter and a separate DC/DC converter. The disadvantage is that related art hybrid and electric vehicles carry two separate devices. However, the inverter and the DC/DC converter are very similar in their technical construction. At present, there is no synergy.

Related art electric motors have a single three-phase system. The electrical power is equally divided between all three phases. An object of the invention is to integrate two 3-phase systems with divided power in one machine. At all motoring operating points at less than half the maximum power, the second three-phase system is isolated from the high-voltage storage device and switched to the low-voltage storage device. While the first three-phase system continues to operate as usual, the second three-phase system supplies the low-voltage storage device.

This allows the separate DC/DC converter to be dispensed with and the inverter is used at all times and the degree of utilization increases. This is also accompanied by lower costs, as a direct current controller is an expensive system component. Furthermore, installation space is gained and weight is saved. In addition the EMC characteristics in the vehicle are improved and the reliability of the vehicle electrics or vehicle electronics is improved, as fewer components which are to be fused are required for the same function.

Other objects, advantages and novel features of the present invention will become apparent from the following detailed description of one or more preferred embodiments when considered in conjunction with the accompanying drawing.

### BRIEF DESCRIPTION OF THE DRAWING

FIG. 1 shows schematically an electrical system with a 6-phase electrical machine.

### DETAILED DESCRIPTION OF THE DRAWING

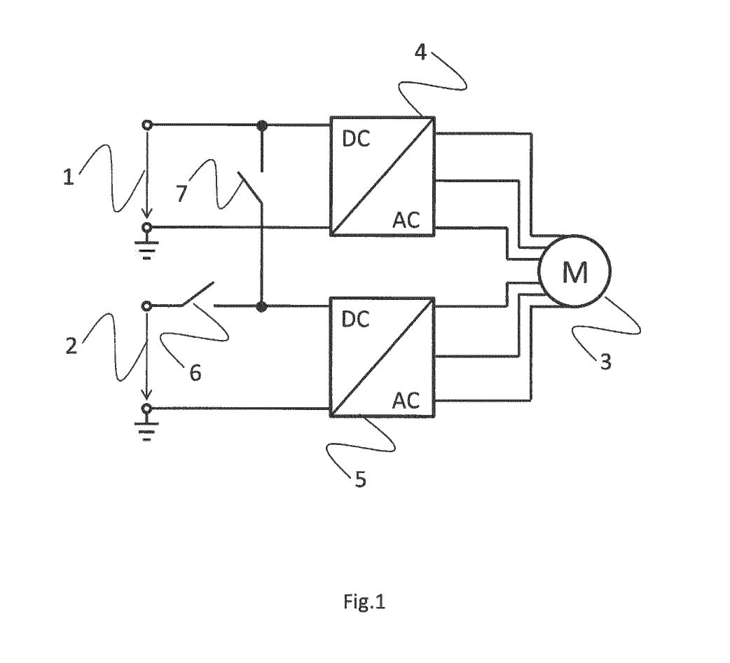

FIG. 1 shows an electrical system, which can be a sub-system of the electrical on-board power supply of a vehicle. The electrical system includes a first energy storage device (1) and a second energy storage device (2). Both energy storage devices can be designed as an electrochemical or an electrical energy storage device, e.g. as a lithium-ion battery, lead-acid battery, or capacitor, and function as energy source or as energy sink depending on the electrical state of the on-board power supply. Both the nominal voltage level and the storage technology of the two storage devices can have different characteristics. This means that typical characteristic curves of the storage devices, e.g. charge and discharge characteristic with respect to charge state or time, do not have to be in a predetermined relationship.

Without restricting this generality, in the following a lithium-ion battery is assumed for the first energy storage device and a super capacitor for the second energy storage device. The nominal voltage level of both storage devices may be 48 V without restricting generality.

The respective pole at lower potential of both storage devices is connected to ground. The respective poles at higher nominal potential, typically the plus poles in the case of batteries, are connected to one another via a first switch (7).

The electrical system also has an electrical machine (3) which is designed with 6 phases. The machine has two stator systems, each with 3 phases, which in each case interact with the rotor of the machine but are electrically isolated from one another. For example, without restricting generality, a separately excited synchronous salient pole machine without damper winding with two 3-phase stator systems can be used. This also includes claw pole machines which are mainly used as generators or starter generators in automobile applications. These generators usually have more than one 3-phase system. In the case of a 6-phase design, the two 3-phase stator systems are implemented electrically offset by 30° with respect to one another.

Furthermore, the electrical system in FIG. 1 has a first bidirectional direct current/alternating current converter (4) which is also denoted as an inverter. This is connected to the first energy storage device. A second bidirectional direct current/alternating current converter (5) is connected to the second energy storage device via a second switch (6). The inverter usually consists of three half-bridges with a link circuit capacitor which are connected to form a B6 circuit. Here, each half-bridge includes two switches, which as a rule are designed as MOSFETs or as IGBTs with an antiparallel diode.

In the following, the person skilled in the art is informed of the known speed/torque behavior of a synchronous motor with a stator system and a rotor.

In the part-load region, it is possible to set the two currents I_{q1} and I_{q2} to different values. Here, I_{q} represents the torque-forming current, wherein I_{q1} designates the torque-forming current of the first stator system and I_{q2} designates the torque-forming current of the second stator system. The first stator system, which is coupled to the first energy storage device, is operated with a positive current I_{q1}, and the second stator system, which is coupled to the second energy storage device, is simultaneously operated with a negative current −I_{q2}. As a result, the first energy storage device is discharged and the machine is operated in motoring mode via the first stator system. The second energy storage device is charged and the machine is operated in generating mode via the second stator system. In order to nevertheless apply a required internal machine torque M_{Mi} for example, I_{q1} must therefore be increased by the magnitude of I_{q2}.

The internal machine torque is given by

M_{Mi}=3/2·Zₚ·(Ψ_{d}·I_{q}−Ψ_{q}·I_{d})

where Zₚ specifies the number of pairs of poles of the machine, i.e. a machine constant, Ψ_{d} the flux in the d-axis, Ψ_{q}, the flux in the q-axis, and I_{d} the flux-forming current.

If a permanently excited electrical machine or a machine with damper windings is used, the relationship is to be adapted in a manner which is obvious to the person skilled in the art without adversely affecting the basic effective relationship.

In the armature adjustment range, the system is usually controlled so that I_{d}=0 A and the required torque of the electrical machine is adjusted by the torque-forming current I_{q}. The above equation for the internal machine torque is then simplified in the armature adjustment range to M_{Mi}=3/2·Zₚ·Ψ_{d}·I_{q}. The machine torque therefore remains dependent only on the flux Ψ_{d} (constant in the armature adjustment range) and on the current I_{q}.

As the machine has two separate stator systems, I_{q} is controlled separately in the two systems. Normally, the setpoint for the two systems is the same and positive I_{q1}=I_{q2}=1/2·I_{q}. In this case, the current I_{q} does not flow directly but is given only as the sum of the torques within the electrical machine. Each sub-system sees only its “own” current I_{q1} or I_{q2} respectively.

If the machine is to be operated in generating mode, then the two setpoints are equal and negative −I_{q1}=−I_{q2}=−1/2·I_{q}.

As well as the purely motoring operation with discharge of the two energy storage devices and the purely generating operation with charging of the two energy storage devices, the electrical system therefore offers the possibility of charging one energy storage device from the other energy storage device via the electrical machine. In this operating mode, the switch (6) is closed and the switch (7) is open.

According to a further variant, both switches can be open. The machine can then only be operated in motoring or generating mode in conjunction with the first energy storage device.

The following table shows thirteen possible operating states of the electrical system in summary:

| | Function of the | |
|---|---|---|
| | two direct | |
| | current/alter- | |
| | nating current | |
| Switch | converters | |
| position | (DCACC) | Effect |
| Switch (6) | None | Freewheel mode (no energy |
| and switch | | consumption) |
| (7) open | | |
| Switch (6) | None | Dead time during transition between |
| and switch | | two operating states to prevent a |
| (7) open | | short-circuit between the first direct |
| | | current source and/or sink and the |
| | | second direct current source and/or |
| | | sink (both switches are open during |
| | | the dead time). |
| Switch (6) | First DCACC | Drive up to half maximum power of |
| and switch | motoring, | the electrical machine with the first |
| (7) open | second DCACC | stator system. Possibly an expedient |
| | “off” | operating state due to the lower |
| | | switching losses with only one stator |
| | | system. |
| Switch (6) | First DCACC | Generator up to half maximum power |
| and switch | generating, | of the electrical machine with the first |
| (7) open | second DCACC | stator system. Possibly an |
| | “off” | advantageous operating state due to |
| | | the lower switching losses with only |
| | | one stator system. |
| Switch (6) | First DCACC | Drive up to half maximum power of |
| open, switch | motoring, | the electrical machine from the first |
| (7) closed | second DCACC | direct current source. Possibly |
| | motoring | advantageous operating state even at |
| | | powers of less than half maximum |
| | | power due to the reduction of ohmic |
| | | losses by dividing the current |
| | | between two stator systems. |
| Switch (6) | First DCACC | Generator up to maximum power of |
| open, switch | generating, | the electrical machine with charging |
| (7) closed | second DCACC | of the first direct current sink. |
| | generating | Possibly advantageous operating state |
| | | even at powers of less than half |
| | | maximum power due to the reduction |
| | | of ohmic losses by dividing the |
| | | current between two stator systems. |
| Switch (6) | First DCACC | Distribution of the drive power of the |
| closed, switch | motoring, | electrical machine between both |
| (7) open | second DCACC | direct current sources. Advantage: |
| | motoring | relieving the load on the individual |
| | | stator systems. |
| Switch (6) | First DCACC | Distribution of the generator power |
| closed, switch | generating, | between both direct current sources |
| (7) open | second DCACC | with charging of both direct current |
| | generating | sinks. Advantage: relieving the load |
| | | on the individual stator systems. |
| Switch (6) | First DCACC | Motoring operation of the electrical |
| closed, switch | “off”, | machine from the second direct |
| (7) open | second DCACC | current source; first direct current |
| | motoring | source and/or sink not in use. |
| | | Electrical machine can be operated up |
| | | to half maximum power as only |
| | | second DCACC in use. |
| Switch (6) | First DCACC | Generating operation of the electrical |
| closed, switch | “off”, | machine with charging of the second |
| (7) open | second DCACC | direct current source; first direct |
| | generating | current source and/or sink not in use. |
| | | Electrical machine can be operated up |
| | | to half maximum power as only the |
| | | second DCACC in use. |
| Switch (6) | First DCACC | Charging of the second direct current |
| closed, switch | motoring, | sink from the first direct current |
| (7) open | second DCACC | source via the electrical machine. |
| | generating | |
| Switch (6) | First DCACC | Charging of the first direct current |
| closed, switch | generating, | sink from the second direct current |
| (7) open | second DCACC | source via the electrical machine. |
| | motoring | |
| Switch (6) | | Inadmissible operating state due to |
| closed, switch | | short-circuit between first direct |
| (7) closed | | current source and/or sink and second |
| | | direct current source and/or sink. |

According to a further embodiment of the electrical system, it is possible instead of the first direct current source and/or sink to integrate an electrical component which functions either exclusively as the first direct current source or exclusively as the first direct current sink. In the case of an exclusive first direct current source, those operating states in the above table in which the first direct current source is assigned the function of a direct current sink are not realizable. This applies correspondingly to the integration of a first direct current sink. Alternatively or in addition, it is also possible instead of the second direct current source and/or sink to integrate an electrical component which functions either exclusively as the second direct current source or exclusively as the second direct current sink. In the case of an exclusive second current source, those operating states in the above table in which the second direct current source is assigned the function of a direct current sink are not realizable. This applies correspondingly to the integration of a second direct current sink.

An electrical system with a 6-phase machine is usually designed in such a way that the two stator systems of the electrical machine are installed offset by 30°. Therefore, in the case of a direct current source and/or sink, two inverters are necessarily required in the electrical system, as the currents and voltages of the stator systems have a phase shift with respect to one another. If a further direct current source and/or sink is to be integrated in the system on this basis, this must be connected via a direct current controller. In each case, the embodiments describe systems in which the electrical machine in combination with the two switches replaces the direct current controller.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An electrical system comprising:
a first 2-pole direct current source and/or sink;
a second 2-pole direct current source and/or sink;
an electrical machine;
a first 3-phase direct current/alternating current converter; and
a second 3-phase direct current/alternating current converter, wherein:
the electrical machine is designed with 6 phases,
the electrical machine has a first 3-phase stator system and a second 3-phase stator system, and
the first stator system is electrically isolated from the second stator system.

2. The electrical system as claimed in claim 1, wherein:
the first stator system is connected to the first direct current/alternating current converter on an alternating current side, and
the second stator system is connected to the second direct current/alternating current converter on the alternating current side.

3. The electrical system as claimed in claim 2, wherein:
the first direct current source and/or sink is connected to the first direct current/alternating current converter on a direct current side, and
the second direct current source and/or sink is connected to the second direct current/alternating current converter on the direct current side.

4. The electrical system as claimed in claim 3, wherein:
the first direct current source and/or sink has a first nominal voltage level and the second direct current source and/or sink has a second nominal voltage level, and
the first nominal voltage level is greater than the second nominal voltage level in a direction of higher homopolar voltage.

5. The electrical system as claimed in claim 4, wherein:
the electrical system further comprises a first switch and a second switch,
a pole with a higher potential of the two poles of the first 2-pole direct current source and/or sink is connected to a pole with a higher potential of the two poles of the second 2-pole direct current source and/or sink via a series circuit of the first switch and the second switch, and
the pole with the higher potential of the two poles of the second 2-pole direct current source and/or sink is connected to the second direct current/alternating current converter via the second switch.

6. The electrical system as claimed in claim 5, wherein:
the second switch is open when the first switch is closed, and
the second switch is closed when the first switch is open.

7. The electrical system as claimed in claim 6, wherein:
when the first switch is closed and the second switch is open, the first 2-pole direct current source and/or sink drives the electrical machine in a motoring mode or a generating mode via the first direct current/alternating current converter and the second direct current/alternating current converter.

8. The electrical system as claimed in claim 6, wherein:
when the first switch is open and the second switch is closed, the first 2-pole direct current source and/or sink drives the electrical machine in the motoring mode via the first direct current/alternating current converter, and
when the first switch is open and the second switch is closed, the second 2-pole direct current source and/or sink charges the electrical machine in the generating mode via the second direct current/alternating current converter.

9. A vehicle comprising:
an electrical system; wherein:
the electrical system comprises:
a first 2-pole direct current source and/or sink;
a second 2-pole direct current source and/or sink;
an electrical machine;
a first 3-phase direct current/alternating current converter; and
a second 3-phase direct current/alternating current converter,
the electrical machine is designed with 6 phases,
the electrical machine has a first 3-phase stator system and a second 3-phase stator system, and
the first stator system is electrically isolated from the second stator system.

10. The vehicle as claimed in claim 9, wherein:
the first stator system is connected to the first direct current/alternating current converter on an alternating current side, and
the second stator system is connected to the second direct current/alternating current converter on the alternating current side.

11. The vehicle as claimed in claim 10, wherein:
the first direct current source and/or sink is connected to the first direct current/alternating current converter on a direct current side, and
the second direct current source and/or sink is connected to the second direct current/alternating current converter on the direct current side.

12. The vehicle as claimed in claim 11, wherein:
the first direct current source and/or sink has a first nominal voltage level and the second direct current source and/or sink has a second nominal voltage level, and
the first nominal voltage level is greater than the second nominal voltage level in a direction of higher homopolar voltage.

13. The vehicle as claimed in claim 12, wherein:
the electrical system further comprises a first switch and a second switch,
a pole with a higher potential of the two poles of the first 2-pole direct current source and/or sink is connected to a pole with a higher potential of the two poles of the second 2-pole direct current source and/or sink via a series circuit of the first switch and the second switch, and
the pole with the higher potential of the two poles of the second 2-pole direct current source and/or sink is connected to the second direct current/alternating current converter via the second switch.

14. The vehicle as claimed in claim 13, wherein:
the second switch is open when the first switch is closed, and
the second switch is closed when the first switch is open.

15. The vehicle as claimed in claim 14, wherein:
when the first switch is closed and the second switch is open, the first 2-pole direct current source and/or sink drives the electrical machine in a motoring mode or a generating mode via the first direct current/alternating current converter and the second direct current/alternating current converter.

16. The vehicle as claimed in claim 15, wherein:
when the first switch is open and the second switch is closed, the first 2-pole direct current source and/or sink drives the electrical machine in the motoring mode via the first direct current/alternating current converter, and
when the first switch is open and the second switch is closed, the second 2-pole direct current source and/or sink charges the electrical machine in the generating mode via the second direct current/alternating current converter.
